(19) United States
(12) Patent Application Publication
(10) Pub. No.: US 2019/0220046 A1
(43) Pub. Date: Jul. 18, 2019

(54) FAUCET

(71) Applicants: CHENG-FENG HUANG, CHANGHUA (TW); YU-LIN HUANG, CHANGHUA (TW)

(72) Inventors: CHENG-FENG HUANG, CHANGHUA (TW); YU-LIN HUANG, CHANGHUA (TW)

(73) Assignee: CHANG PENG METAL INDUSTRIAL CO., LTD., Changhua (TW)

(21) Appl. No.: 15/871,965

(22) Filed: Jan. 15, 2018

(51) Int. Cl. G05D 23/13

(52) U.S. Cl. CPC G05D 23/1313

(57) ABSTRACT

A faucet may comprise a main body, a ceramic control valve, a locating sleeve and a faucet head, and a pulling rod is connected at a lateral side of the faucet head for the operation of the faucet. The faucet head with the pulling rod is positioned at a front side of the faucet, which is convenient for a user to operate the faucet and saves water during the process of operating the faucet.

### FIELD OF THE INVENTION

The present invention relates to a faucet and more particularly to a faucet easy for use.

### BACKGROUND OF THE INVENTION

A conventional faucet is generally installed on a kitchen counter around a sink and comprises at least two water channels which respectively connect to hot water source and cold water source. Moreover, the faucet has a spout and a ceramic control valve respectively formed at a top portion and an interior portion thereof. An end of the spout is connected to a faucet head, and the control valve having a driving valve piece and a fixed valve piece is connected to a control handle. Furthermore, the control handle is adapted to drive the driving valve piece to change relative positions between the driving valve piece and the fixed valve piece, thereby controlling on/off operation of the faucet, ratio of hot and cold water, and the amount of water flow.

However, the conventional faucet is disadvantageous because: the control valve only can be installed in the faucet at a side position, which makes the operation of the faucet more difficult and wastes more water during the process of operating the faucet. Therefore, there remains a need for a new and improved design for a faucet to overcome the problems presented above.

### SUMMARY OF THE INVENTION

The present invention provides a faucet which comprises a main body, a ceramic control valve, a locating sleeve and a faucet head. The main body has a rigid gooseneck spout at a top portion thereof, and two water guiding members installed in the spout are configured to connect to cold and hot water sources respectively. An upper end of the spout has a water outlet end, and a head base is installed inside the water outlet end. A first end of the head base comprises a chamber, and two water inlet holes penetrating from a bottom portion of the chamber toward a second end of the head base are adapted to respectively connect and communicate with the two water guiding members. Furthermore, an outer periphery of the first end of the head base has a first connecting section, and the first connecting section is configured to protrude from the water outlet end when the head base is coupled in the spout. The control valve has a valve shell, and a rotating base is installed therein. A lower portion of the rotating base is coupled with a driving valve piece, and a lower portion of the driving valve piece is coupled with a fixed valve piece, wherein the driving valve piece and the fixed valve piece are positioned in the valve shell. A center of a top portion of the rotating base comprises a valve tube upwardly sticking out of the valve shell. The rotating base is configured to engage with the driving valve piece, and through operating the valve tube, the rotating base driven by the valve tube is adapted to drive and have synchronous rotation with the driving valve piece so as to change the relative positions between the driving valve piece and the fixed valve piece and then to control on/off operation of the faucet, ratio of hot and cold water and the amount of water flow. A valve base is configured to couple with and block a bottom portion of the valve shell, thereby securing the fixed valve piece, the driving valve piece and the rotating base in the valve shell. Moreover, the fixed valve piece has a second through hole and a third through hole while the valve base comprises a fourth through hole and the fifth through hole, wherein the second through hole of the fixed valve piece is configured to align with the fourth through hole of the valve base for passing by cold water while the third through hole of the fixed valve piece is adapted to align with the fifth through hole of the valve base for passing by hot water. A mixing hole is located between the second through hole and the third through hole on the fixed valve piece. Additionally, the driving valve piece has a first through hole penetrating through a central portion thereof, and two lateral sides of the first through hole respectively connect to a first extending portion and a second extending portion. When the valve tube is not operated, each of the first extending portion and the second extending portion is fully misaligned with the second through hole and the third through hole of the fixed valve piece such that cold and hot water are blocked by the driving valve piece and not flow out from the valve tube of the control valve. The locating sleeve has a coupling hole axially penetrating therethrough, and a second connecting section is formed on an inner periphery of the coupling hole. Furthermore, an annular edge protrudes from the inner periphery of the coupling hole. The control valve is positioned into the chamber of the head base through the valve base, and the fourth through hole and the fifth through hole are respectively communicated with the two water inlet holes. Thereafter, the second connecting section is connected to the first connecting section, and the annular edge is configured to bear against and limit a position of the control valve in the chamber. After the locating sleeve connected to the control valve, the valve tube is configured to penetrate through the coupling hole and downwardly stick out of the locating sleeve. The faucet head has a water outlet channel which axially penetrates through a central portion thereof, and the faucet head is configured to dispose on the valve tube to enable the valve tube to be positioned in the water outlet channel. Moreover, a pulling rod is connected at a lateral side of the faucet head, and through pulling the pulling rod, a user can control on/off operation of the faucet and ratio of hot and cold water.

Comparing with conventional faucet, the present invention is advantageous because: the faucet head with the pulling rod is positioned at a front side of the faucet, which is convenient for a user to operate the faucet and saves water during the process of operating the faucet.

### BRIEF DESCRIPTION OF THE DRAWINGS

FIG. 1 is a three-dimensional assembly view of a faucet of the present invention.

FIG. 2 is a three-dimensional exploded view of the faucet of the present invention.

FIG. 3 is a detailed exploded view of a ceramic control valve of the faucet of the present invention.

FIG. 4 is a plan view of a driving valve piece of the faucet of the present invention.

FIG. 5 is a plan view of a fixed valve piece of the faucet of the present invention.

FIG. 6 is a schematic view illustrating relative positions between the driving valve piece and the fixed valve piece when the faucet of the present invention is turned off.

FIG. 7 is a sectional assembly view of the faucet of the present invention.

FIG. 8 is a sectional assembly view from another angle of the faucet of the present invention.

FIG. 9 is a schematic view illustrating a pulling rod is pulled to operate the faucet of the present invention.

FIG. 10 is a schematic view illustrating relative positions between the driving valve piece and the fixed valve piece when only cold water flows out from the faucet of the present invention.

FIG. 11 is a schematic view illustrating relative positions between the driving valve piece and the fixed valve piece when warm water mixed from cold and hot water flows out from the faucet of the present invention.

FIG. 12 is a schematic view illustrating relative positions between the driving valve piece and the fixed valve piece when only hot water flows out from the faucet of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

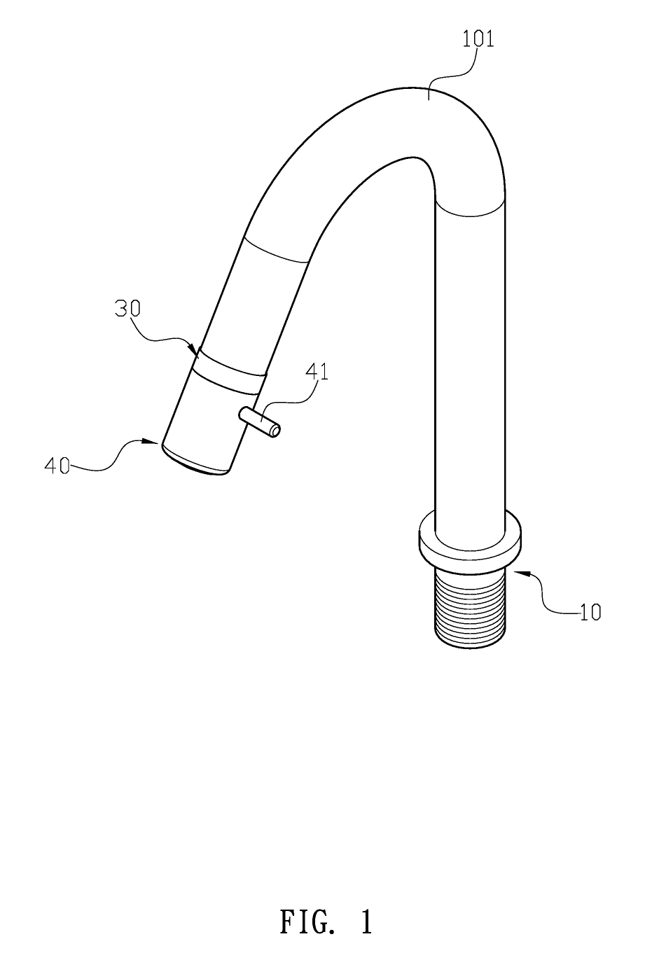

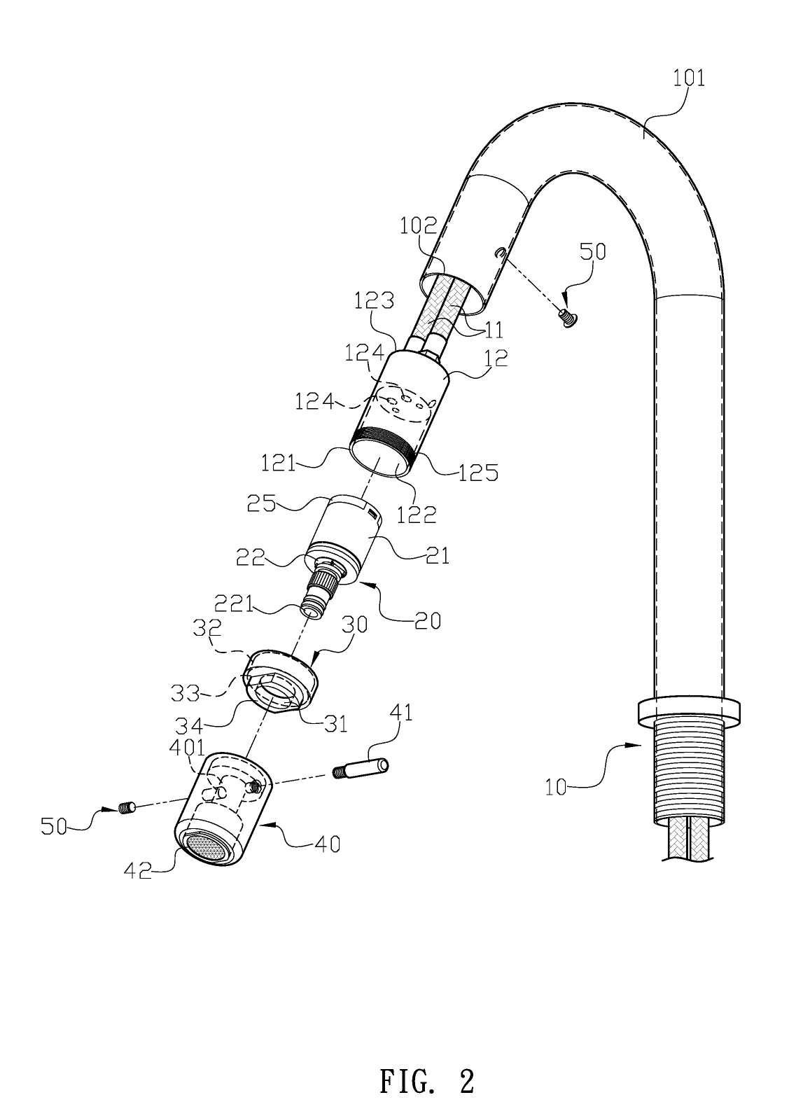

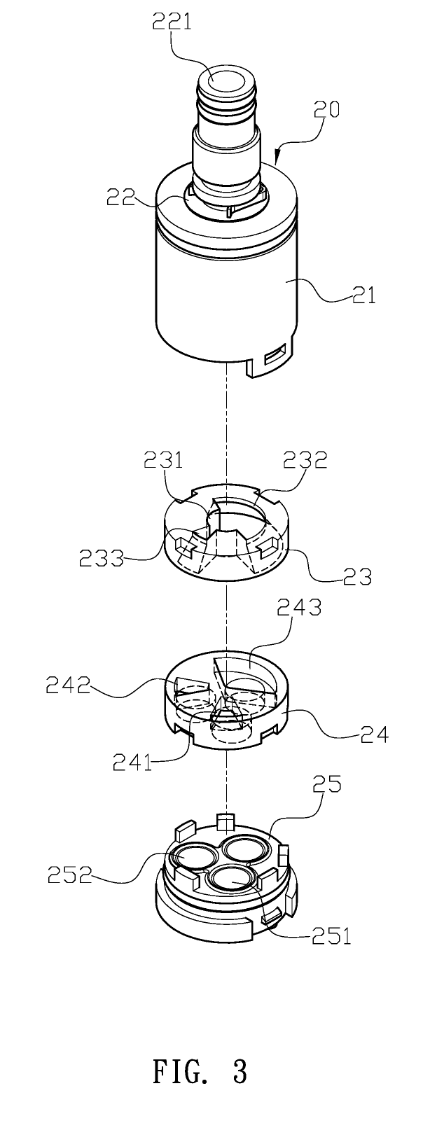

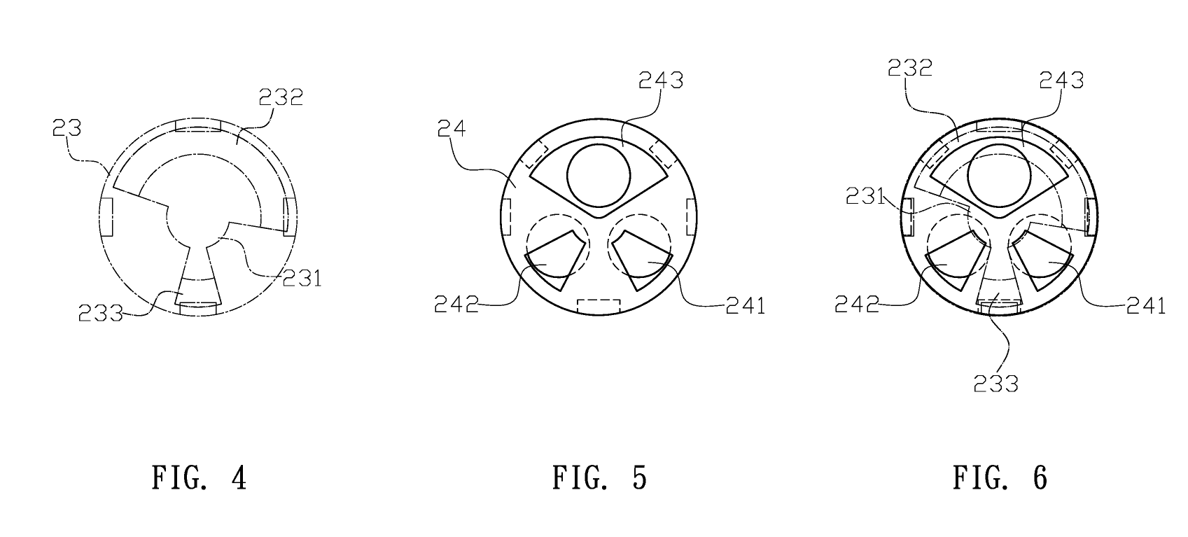

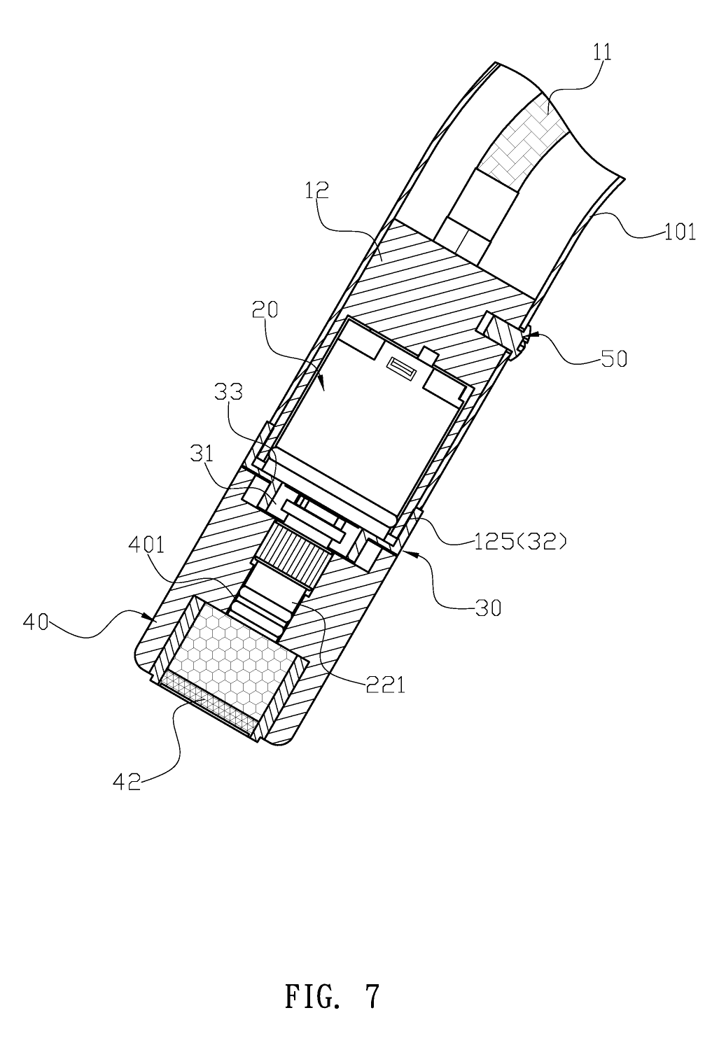

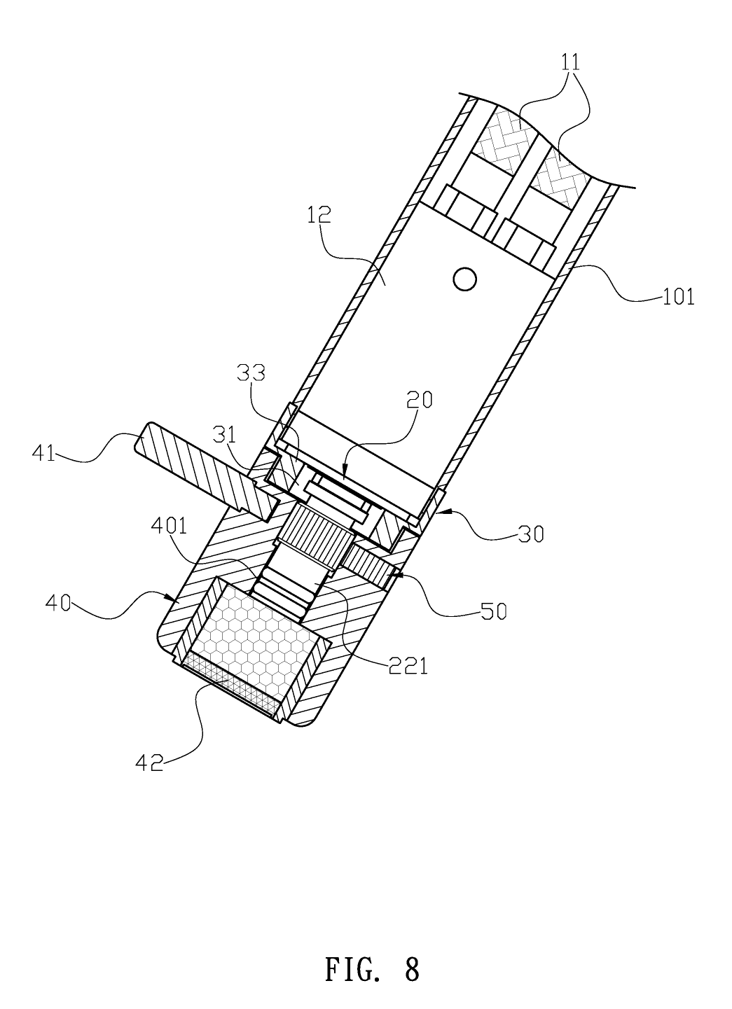

Referring to FIGS. 1 to 8, the present invention provides a faucet which comprises a main body (10), a ceramic control valve (20), a locating sleeve (30) and a faucet head (40). The main body (10) has a rigid gooseneck spout (101) at a top portion thereof, and two water guiding members (11) installed in the spout (101) are configured to connect to cold and hot water sources respectively. An upper end of the spout (101) has a water outlet end (102), and a head base (12) is installed inside the water outlet end (102). A first end (121) of the head base (12) comprises a chamber (122), and two water inlet holes (124) penetrating from a bottom portion of the chamber (122) toward a second end (123) of the head base (12) are adapted to respectively connect and communicate with the two water guiding members (11). Furthermore, an outer periphery of the first end (121) of the head base (12) has a first connecting section (125), and the first connecting section (125) is configured to protrude from the water outlet end (102) when the head base (12) is coupled in the spout (101). The control valve (20) has a valve shell (21), and a rotating base (22) is installed therein. A lower portion of the rotating base (22) is coupled with a driving valve piece (23), and a lower portion of the driving valve piece (23) is coupled with a fixed valve piece (24), wherein the driving valve piece (23) and the fixed valve piece (24) are positioned in the valve shell (21). A center of a top portion of the rotating base (22) comprises a valve tube (221) upwardly sticking out of the valve shell (21). The rotating base (22) is configured to engage with the driving valve piece (23), and through operating the valve tube (221), the rotating base (22) driven by the valve tube (221) is adapted to drive and have synchronous rotation with the driving valve piece (23) so as to change the relative positions between the driving valve piece (23) and the fixed valve piece (24) and then to control on/off operation of the faucet, ratio of hot and cold water and the amount of water flow. A valve base (25) is configured to couple with and block a bottom portion of the valve shell (21), thereby securing the fixed valve piece (24), the driving valve piece (23) and the rotating base (22) in the valve shell (21). Moreover, the fixed valve piece (24) has a second through hole (241) and a third through hole (242) while the valve base (25) comprises a fourth through hole (251) and the fifth through hole (252), wherein the second through hole (241) of the fixed valve piece (24) is configured to align with the fourth through hole (251) of the valve base (25) for passing by cold water while the third through hole (242) of the fixed valve piece (24) is adapted to align with the fifth through hole (252) of the valve base (25) for passing by hot water. A mixing hole (243) is located between the second through hole (241) and the third through hole (242) on the fixed valve piece (24). Additionally, the driving valve piece (23) has a first through hole (231) penetrating through a central portion thereof, and two lateral sides of the first through hole (231) respectively connect to a first extending portion (232) and a second extending portion (233). When the valve tube (221) is not operated, each of the first extending portion (232) and the second extending portion (233) is fully misaligned with the second through hole (241) and the third through hole (242) of the fixed valve piece (24) such that cold and hot water are blocked by the driving valve piece (23) and not flow out from the valve tube (221) of the control valve (20). The locating sleeve (30) has a coupling hole (31) axially penetrating therethrough, and a second connecting section (32) is formed on an inner periphery of the coupling hole (31). Furthermore, an annular edge (33) protrudes from the inner periphery of the coupling hole (31). The control valve (20) is positioned into the chamber (122) of the head base (12) through the valve base (25), and the fourth through hole (251) and the fifth through hole (252) are respectively communicated with the two water inlet holes (124). Thereafter, the second connecting section (32) is connected to the first connecting section (125), and the annular edge (33) is configured to bear against and limit a position of the control valve (20) in the chamber (122). After the locating sleeve (30) connected to the control valve (20), the valve tube (221) is configured to penetrate through the coupling hole (31) and downwardly stick out of the locating sleeve (30). The faucet head (40) has a water outlet channel (401) which axially penetrates through a central portion thereof, and the faucet head (40) is configured to dispose on the valve tube (221) to enable the valve tube (221) to be positioned in the water outlet channel (401). Moreover, a pulling rod (41) is connected at a lateral side of the faucet head (40), and through pulling the pulling rod (41), a user can control on/off operation of the faucet and ratio of hot and cold water.

In one embodiment, each of the water guiding members (11) is a flexible metal hose.

In another embodiment, the head base (12) is connected with the spout (101) through at least a screw (50).

In still another embodiment, the first connecting section (125) and the second connecting section (32) respectively have an outer threaded section and an inner threaded section thereon to engage together.

In a further embodiment, a driving block (34) protruding from a bottom portion of the locating sleeve (30) is configured to be caught by a tool such as a wrench to have synchronous rotation, and a diameter of the driving block (34) is smaller than the locating sleeve (30).

In still a further embodiment, each of the first extending portion (232) and the second extending portion (233) is a downward inclined surface extending from the first through hole (231).

In a preferred embodiment, each of the first extending portion (232) and the second extending portion (233) is formed in a fan shape, and the first extending portion (232) is larger than the second extending portion (233).

In still a preferred embodiment, the mixing hole (243) is a recess on a top surface of the fixed valve piece (24).

In an advantageous embodiment, the faucet head (40) is connected with the valve tube (221) through at least a screw (50).

In still an advantageous embodiment, a faucet aerator (42) is installed in the water outlet channel (401) below the valve tube (221).

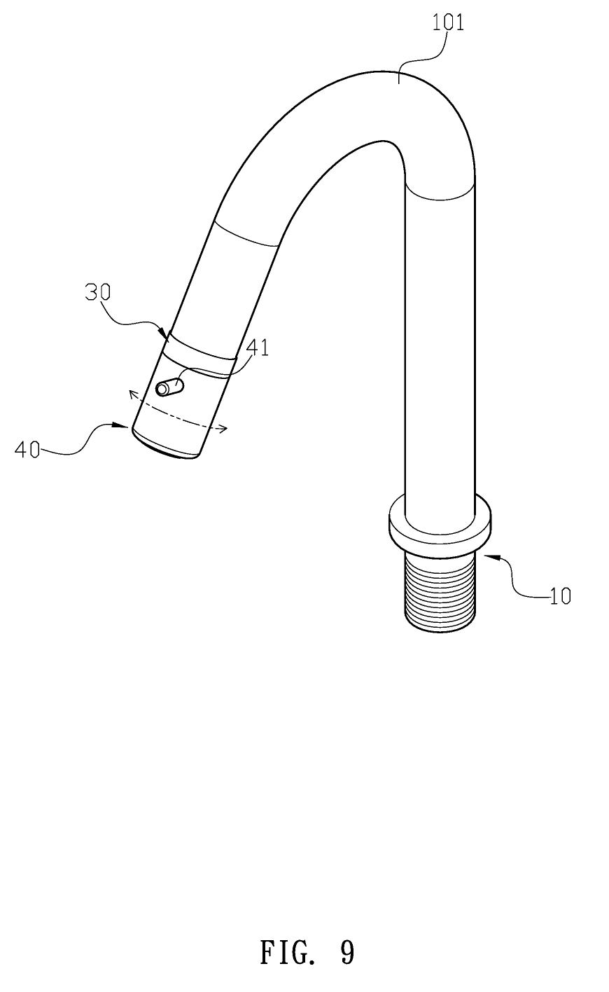

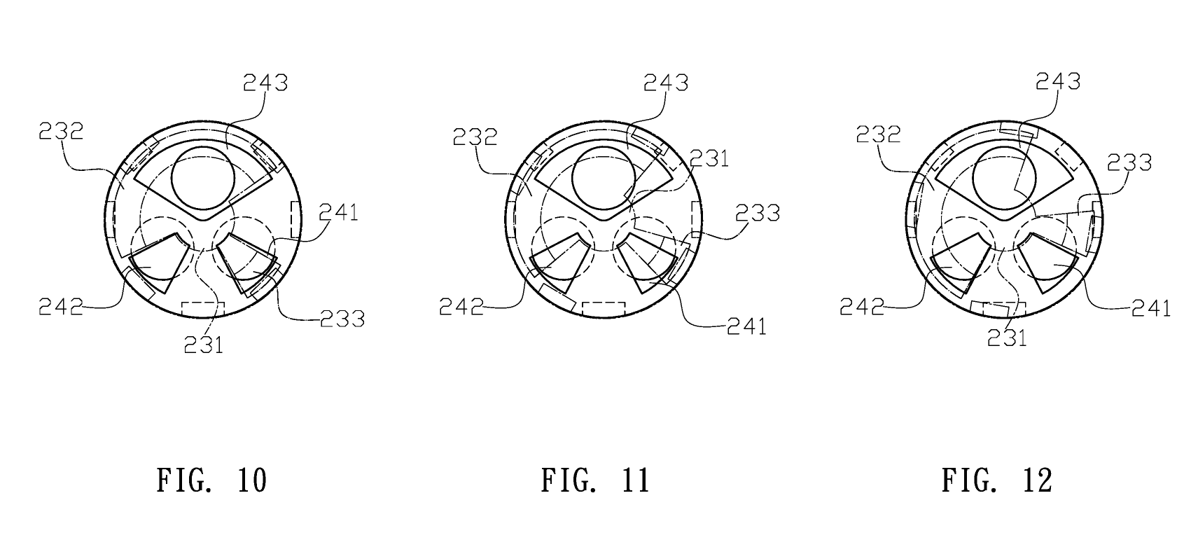

In actual application, through pulling the pulling rod (41) (as shown in FIG. 9), the valve tube (221) is configured to drive the rotating base (22) and the driving valve piece (23) to have synchronous rotations. Through aligning the second extending portion (233) with the second through hole (241) (as shown in FIG. 10), cold water is adapted to flow from one of the water guiding members (11), one of the water inlet holes (124), the fourth through hole (251) and the second through hole (241) into the control valve (20), and then flows through the second extending portion (233), the first through hole (231), and the valve tube (221) and out of the faucet from the faucet head (40). When warm water or hot water is needed, a user can continue to pull the pulling rod (41) further away from an initial position, and the first extending portion (232) is configured to gradually overlap with the third through hole (242). When the first extending portion (232) and the second extending portion (233) are communicated with the third through hole (242), the second through hole (241) and mixing hole (243) simultaneously (as shown in FIG. 11), cold and hot water are configured to be mixed to form warm water flowing out of the faucet. When the pulling rod (41) travels farthest to reach the other end of the initial position, the second extending portion (233) is adapted to totally misalign with the second through hole (241) and the first extending portion (232) is configured to entirely cover the third through hole (242) (as shown in FIG. 12), thereby enabling the faucet to discharge only hot water. Also, the user can pull the handle (50) back to its initial position to turn off the faucet.

Comparing with conventional faucet, the present invention is advantageous because: the faucet head (40) with the pulling rod (41) is positioned at a front side of the faucet, which is convenient for a user to operate the faucet and saves water during the process of operating the faucet.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A faucet comprising a main body, a ceramic control valve, a locating sleeve and a faucet head;
wherein the main body has a rigid gooseneck spout at a top portion thereof, and two water guiding members installed in the spout are configured to connect to cold and hot water sources respectively; an upper end of the spout has a water outlet end, and a head base is installed inside the water outlet end; a first end of the head base comprises a chamber, and two water inlet holes penetrating from a bottom portion of the chamber toward a second end of the head base are adapted to respectively connect and communicate with the two water guiding members; an outer periphery of the first end of the head base has a first connecting section, and the first connecting section is configured to protrude from the water outlet end when the head base is coupled in the spout;
wherein the control valve has a valve shell, and a rotating base is installed therein; a lower portion of the rotating base is coupled with a driving valve piece, and a lower portion of the driving valve piece is coupled with a fixed valve piece, wherein the driving valve piece and the fixed valve piece are positioned in the valve shell; a center of a top portion of the rotating base comprises a valve tube upwardly sticking out of the valve shell; the rotating base is configured to engage with the driving valve piece, and through operating the valve tube, the rotating base driven by the valve tube is adapted to drive and have synchronous rotation with the driving valve piece so as to change the relative positions between the driving valve piece and the fixed valve piece and thereby to control on/off operation of the faucet, ratio of hot and cold water and the amount of water flow; a valve base is configured to couple with and block a bottom portion of the valve shell, thereby securing the fixed valve piece, the driving valve piece and the rotating base in the valve shell; the fixed valve piece has a second through hole and a third through hole while the valve base comprises a fourth through hole and the fifth through hole, wherein the second through hole of the fixed valve piece is configured to align with the fourth through hole of the valve base for passing by cold water while the third through hole of the fixed valve piece is adapted to align with the fifth through hole of the valve base for passing by hot water; a mixing hole is located between the second through hole and the third through hole on the fixed valve piece; the driving valve piece has a first through hole penetrating through a central portion thereof, and two lateral sides of the first through hole respectively connect to a first extending portion and a second extending portion; when the valve tube is not operated, each of the first extending portion and the second extending portion is completely misaligned with the second through hole and the third through hole of the fixed valve piece such that cold and hot water are blocked by the driving valve piece and not flow out from the valve tube of the control valve;
wherein the locating sleeve has a coupling hole axially penetrating therethrough, and a second connecting section is formed on an inner periphery of the coupling hole; an annular edge protrudes from the inner periphery of the coupling hole; the control valve is positioned into the chamber of the head base through the valve base, and the fourth through hole and the fifth through hole are respectively communicated with the two water inlet holes, and the second connecting section is connected to the first connecting section, and the annular edge is configured to bear against and limit a position of the control valve in the chamber; after the locating sleeve connected to the control valve, the valve tube is configured to penetrate through the coupling hole and downwardly stick out of the locating sleeve; and
wherein the faucet head has a water outlet channel which axially penetrates through a central portion thereof, and the faucet head is configured to dispose on the valve tube to enable the valve tube to be positioned in the water outlet channel; a pulling rod connected at a lateral side of the faucet head is configured to control on/off operation of the faucet and ratio of hot and cold water.

2. The faucet of claim 1, wherein each of the water guiding members is a flexible metal hose.

3. The faucet of claim 1, wherein the head base is connected with the spout through at least a screw.

4. The faucet of claim 1, wherein the first connecting section and the second connecting section respectively have an outer threaded section and an inner threaded section thereon to engage together.

5. The faucet of claim 1, wherein a driving block protruding from a bottom portion of the locating sleeve has a diameter smaller than the locating sleeve.

6. The faucet of claim 1, wherein each of the first extending portion and the second extending portion is a downward inclined surface extending from the first through hole.

7. The faucet of claim 1, wherein each of the first extending portion and the second extending portion is formed in a fan shape, and the first extending portion is larger than the second extending portion.

8. The faucet of claim 1, wherein the mixing hole is a recess on a top surface of the fixed valve piece.

9. The faucet of claim 1, wherein the faucet head is connected with the valve tube through at least a screw.

10. The faucet of claim 1, wherein a faucet aerator is installed in the water outlet channel below the valve tube.
